(19) United States
(12) Patent Application Publication
(10) Pub. No.: US 2008/0292279 A1
(43) Pub. Date: Nov. 27, 2008

(54) DIGEST PLAYBACK APPARATUS AND METHOD

(76) Inventors: Takashi KAMADA, Osaka (JP); Naoki EJIMA, Osaka (JP)

Correspondence Address: MCDERMOTT WILL & EMERY LLP, 600 13TH STREET, NW, WASHINGTON, DC, 20005-3096, US

(21) Appl. No.: 12/032,504

(22) Filed: Feb. 15, 2008

(30) Foreign Application Priority Data
May 22, 2007 (JP) 2007-135900

(51) Int. Cl. H04N 7/26; G06K 9/00; G10L 15/00

(52) U.S. Cl. 386/124; 382/181; 704/246

(57) ABSTRACT

A character identification section identifies characters to specify one or more characters in each of scenes in video content according to video data in the video content, and generates images of the identified characters. A speaker identification section identifies speakers to specify one or more speakers in each of the scenes in the video content according to subtitle data in the video content. A correspondence determination section determines, based on results of the specification of the characters and the specification of the speakers in the scenes in the video content, a correspondence between each of the characters and each of the speakers. A display control section controls display of the images of the characters to receive selection of a character desired by a user, and plays back one or more of the scenes in the video content in which the speaker speaks, who is determined to correspond to the selected character.

### CROSS REFERENCE TO RELATED APPLICATION

The disclosure of Japanese Patent Application No. 2007-135900 filed on May 22, 2007 including specification, drawings and claims is incorporated herein by reference in its entirety.

### BACKGROUND OF THE INVENTION

1. Field of the Invention

The present invention relates to a digest playback apparatus and method for playing back a digest of video content, and more particularly relates to a technique for playing back a digest focusing on characters.

2. Description of the Related Art

With the recent digitization of television broadcasting, apparatuses for recording video content on recording media, such as a hard disk, DVD (Digital Versatile Disc), and BD (Blu-ray Disc), and playing back the recorded content are becoming increasingly common. In addition, apparatuses having the function of utilizing the features of digitized video content to extract highlight scenes and playing back a digest of the video content are coming along.

An apparatus has been conventionally known which extracts highlight scenes according to the audio level of video content (see Japanese Laid-Open Publication No. 10-32776, for example). For instance, in the case of sports programs, in which the crowd presumably cheers in enjoyable scenes, such a technique enables highlight scenes to be extracted with higher accuracy. Another apparatus has also been known which identifies human faces based on video data in video content and extracts scenes which contain images of specific characters (see, e.g., Japanese Laid-Open Publication No. 2005-33276).

However, for genres in which audio level and enjoyable scenes are not necessarily correlated with each other, such as talk shows, music programs, and dramas, the highlight scene extraction accuracy in the former technique may deteriorate extremely. In other words, genres to which the former technique is applicable are quite limited.

On the other hand, the latter technique enables extraction of highlight scenes even in the genres to which the former technique is not applicable. Nevertheless, scenes of relatively low importance, such as scenes in which a specific character appears but does not speak any lines, might be extracted as highlight scenes. That is, scenes in which the specific character appears are given higher priority than conversation scenes which are considered to be important to the user. In addition, scenes which are important for an understanding of the outline of the content, such as a scene in which the specific character does not appear but speaks his or her lines, may not be extracted.

### SUMMARY OF THE INVENTION

In view of the above drawbacks, it is therefore an object of the present invention to play back scenes in video content provided by digital broadcasting, etc., which are related to a character specified from the video content, particularly scenes in which the specified character speaks, as a digest of the video content.

In order to achieve the object, an inventive apparatus for playing back a digest of recorded video content includes: a character identification section for identifying characters to specify one or more characters in each of scenes in the video content according to video data in the video content, and generating images of the identified characters; a speaker identification section for identifying speakers to specify one or more speakers in each of the scenes in the video content according to subtitle data in the video content; a correspondence determination section for determining, based on results of the character identification section's specification of the characters and the speaker identification section's specification of the speakers in the scenes in the video content, a correspondence between each of the characters identified by the character identification section and each of the speakers identified by the speaker identification section; and a display control section for controlling display of the images of the characters generated by the character identification section to receive selection of a character desired by a user, and playing back one or more of the scenes in the video content in which a speaker speaks, who is determined to correspond to the selected character by the correspondence determination section. Also, an inventive method for playing back a digest of recorded video content includes the steps of: (a) identifying characters to specify one or more characters in each of scenes in the video content according to video data in the video content, and generating images of the identified characters; (b) identifying speakers to specify one or more speakers in each of the scenes in the video content according to subtitle data in the video content; (c) determining, based on results of the specification of the characters and the specification of the speakers in the scenes in the video content performed in the steps (a) and (b), a correspondence between each of the characters identified in the step (a) and each of the speakers identified in the step (b); and (d) displaying the images of the characters generated in the step (a) to receive selection of a character desired by a user, and playing back one or more of the scenes in the video content in which a speaker speaks, who is determined to correspond to the selected character in the step (c).

According to the inventive apparatus and method, the characters and the speakers in the scenes are specified according to the video data and the subtitle data in the video content, the correspondences between the identified characters and speakers are determined based on the specification results, and the scenes in which the speaker corresponding the user's desired character speaks are played back. It is thus possible to play back, as a digest, the scenes in which the user's desired character speaks.

When switching occurs between speakers identified by the speaker identification section, the character identification section preferably identifies a character by referring to a still image contained in the video data at the time of the occurrence of the switching. The same holds true for the step (a). This reduces the number of times the character identifying processing, which requires relatively heavy processing load, is performed.

Specifically, the character identification section performs a discrete cosine transform on part of a still image contained in the video data which shows a face of a human, and identifies a character by a code obtained by the transform. The same holds true for the step (a).

Also, specifically, the speaker identification section obtains information on colors of letters of subtitles or textual information added to the subtitles from the subtitle data, and identifies the speakers according to the letter color information or the textual information. The same holds true for the step (b).

Furthermore, to be specific, if there is a scene which has been determined to have one character by the character identification section and determined to have one speaker by the speaker identification section, the correspondence determination section determines that the character and the speaker correspond to each other. If there is a scene which has been determined to have n characters by the character identification section and determined to have n speakers by the speaker identification section, and in which correspondences between n−1 characters of the n characters and n−1 speakers of the n speakers have already been determined, the correspondence determination section determines that the remaining one character and the remaining one speaker correspond to each other. The same holds true for the step (c).

The speaker identification section preferably calculates, for each of the scenes in the video content, a ratio of a subtitle display time for each speaker in that scene to the duration of that scene; and when there are a plurality of scenes that satisfy said conditions, the correspondence determination section preferably determines, based on results of the character identification section's specification of the characters and the speaker identification section's specification of the speakers for one of the scenes in which the ratio calculated by the speaker identification section is larger than the ratios in others of the scenes, a correspondence between each of the characters identified by the character identification section and each of the speakers identified by the speaker identification section. The same holds true for the steps (b) and (d). In the scene in which the ratio of the speaker's subtitle display time is large, the character and the speaker presumably more closely correspond to each other. Thus, the correspondence between the character and the speaker is determined more reliably.

Moreover, preferably, the speaker identification section calculates, for each of the scenes in the video content, a ratio of a subtitle display time for each speaker in that scene to the duration of that scene; and preferably, the display control section preferentially plays back a scene, in which the ratio calculated by the speaker identification section for the speaker who has been determined to correspond to the selected character by the correspondence determination section is larger than the ratios in others of the scenes. The same holds true for the steps (b) and (d). Then, the scene in which the user's desired character speaks many lines is played back preferentially, enabling the playback of a digest that facilitates an understanding of the story.

Specifically, the display control section preferentially plays back a scene close to an end of the video content. Alternatively, the display control section equally plays back scenes at a beginning, in a middle and at an end of the video content. The same holds true for the step (d).

The content playback apparatus preferably includes a storage section for storing the images of the characters generated by the character identification section and results of the determination made by the correspondence determination section, while associating the images and the determination results with a series of programs in the video content. And when the display control section plays back a video content which is an episode of a series, the display control section preferably controls display of the images of the characters in the series, which are stored in the storage section, to receive selection of a character desired by a user, and plays back one or more of the scenes in the video content, in which a speaker speaks, who is determined to correspond to the selected character according to the results of the determination made for the series by the correspondence determination section and stored in the storage section. Also, the content playback method preferably includes the steps of: (e) storing the images of the characters generated in the step (a) and results of the determination made in the step (c), while associating the images and the determination results with a series of programs in the video content; and (f) when a video content which is an episode of a series is played back, displaying the images of the characters in the series, which are stored in the step (e) to receive selection of a character desired by a user, and playing back one or more of the scenes in the video content, in which a speaker speaks, who is determined to correspond to the selected character according to the results of the determination made for the series in the step (c) and stored in the step (e). Then, in playing back a digest of a video content which is an episode of a series, it is not necessary to determine the correspondences between the characters and the speakers again.

### BRIEF DESCRIPTION OF THE DRAWINGS

FIG. 1 illustrates the structure of a digest playback apparatus according to an embodiment of the invention.

FIG. 2 is a flowchart showing the flow of operation performed by the digest playback apparatus shown in FIG. 1.

FIG. 3 schematically shows how highlight scenes are extracted.

### DETAILED DESCRIPTION OF THE INVENTION

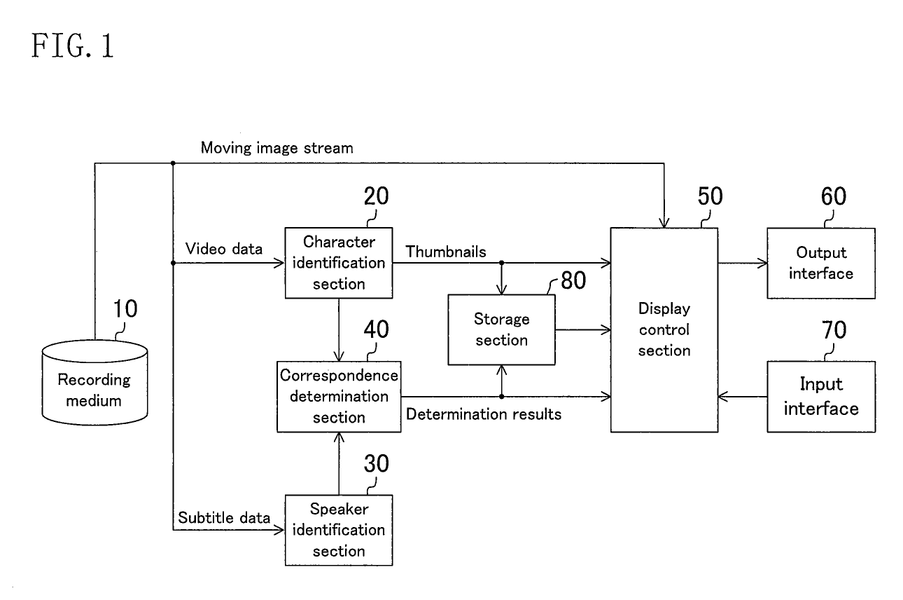

Hereinafter, the preferred embodiments of the present invention will be described with reference to the accompanying drawings. FIG. 1 illustrates the structure of a digest playback apparatus according to an embodiment of the invention. Video content divided into several scenes is stored in a recording medium 10. The video content, which was obtained by recording an MPEG-2 moving image stream provided by digital broadcasting or the like, contains video data, audio data, subtitle data, and other additional information. The recording medium 10 is composed of a hard disk, DVD, BD, or flash memory, for example.

A character identification section 20 captures a still image (e.g., an MPEG-2 I-frame) from the video data in the video content recorded in the recording medium 10 and performs sampling of part of the still image that has a certain pixel size. And the character identification section 20 searches through that sampled image for a symmetric image. When a symmetric image is found, the character identification section 20 rotates, translates, scales up/down, and crops the symmetric image with respect to the original still image, with the center of the symmetric image being the base point. Thereafter, assuming that the extracted image is a facial image whose base point is the midpoint between both eyes, the character identification section 20 puts the nose, the mouth, the ears and the like into the extracted image to determine whether or not the extracted image is actually a facial image. If the extracted image is not a facial image, the character identification section 20 discards these pieces of data, changes the search conditions, and searches for a facial image again. If it is determined that the extracted image is a facial image, the character identification section 20 generates a thumbnail of a character from the facial image, while producing a face ID for that character.

To produce the face ID, the character identification section 20 normalizes the extracted image that has been determined to be the facial image to a predetermined number of pixels and performs a two-dimensional discrete cosine transform (DCT) on the normalized image. As a result of the DCT, a DCT coefficient and a DCT code are derived. The position of the DCT code is information which largely relates to the facial contour and thus well represents the features of the human face. That is, the DCT code of the facial image can be a suitable index for identification of the character. The character identification section 20 therefore uses the DCT codes of facial images as face IDs in identifying characters to specify each character in each scene in the video content recorded in the recording medium 10. Even if the DCT codes of facial images are decimated according to certain rules, the above described feature is hardly lost, and hence the decimated DCT codes may be used as face IDs.

To specify each character in each scene, the character identification section 20 does not need to refer to all still images contained in the video data for that scene, but only needs to refer to a still image or images contained in the video data in which speakers identified by a speaker identification section 30, which will be described later, are switched. This reduces the processing load required for the character specification for each scene, enabling the processing speed to be enhanced and the power consumption to be lowered.

The speaker identification section 30 obtains information on the colors of letters of subtitles from the subtitle data in the video content recorded in the recording medium 10 and identifies speakers according to the obtained information. The subtitle letter color information is embedded as control data in parts of the subtitle data in which the subtitle letter color changes. For example, in a case in which the color of letters changes from red to white, the control data, composed of a control identification code, a color number and the like, is inserted in the subtitle data between the subtitles that are displayed in red and the subtitles that are displayed in white. The speaker identification section 30 identifies the speaker by the subtitle letter color to specify each speaker in each scene in the video content recorded in the recording medium 10.

The speakers may be identified by textual information added to the subtitles other than by the subtitle letter color information. For instance, in some cases, at the beginning of subtitles for each line, the name of the character who speaks that line is displayed within parentheses. If such textual information is present, the use of the textual information makes the speakers easily identifiable as in the case where the subtitle letter colors are used.

Furthermore, the speaker identification section 30 may calculate, for each of the scenes, the ratio of a subtitle display time for each speaker in that scene to the duration of that scene. As will be discussed later, in a case where digest playback time is specified, the calculated ratios are used as indexes to sort out scenes so that the digest is within the specified time.

For each speaker identified by the speaker identification section 30, a correspondence determination section 40 determines which one of the characters identified by the character identification section 20 is that speaker. To be specific, (1) if there is a scene that has been determined to have therein one character and one speaker, the correspondence determination section 40 determines that the character and the speaker correspond to each other; and (2) if there is a scene that has been determined to have therein n characters and n speakers, and correspondences between n-i characters of the n characters and n-i speakers of the n speakers have already been determined, the correspondence determination section 40 determines that the remaining one character and the remaining one speaker correspond to each other.

In the situations (1) and (2), if there are a plurality of scenes that meet the above-described conditions, and the ratio of the subtitle display time for each speaker has been calculated by the speaker identification section 30, a scene in which that ratio is larger is considered preferentially. In such a scene, the character and the speaker presumably more closely correspond to each other. Thus, by considering such a scene preferentially, it is possible to determine the correspondence between the character and the speaker more reliably.

A display control section 50 presents the thumbnails of the characters generated by the character identification section 20 to the user through an output interface 60 to receive through an input interface 70 character selection made by the user. And the display control section 50 reads from the recording medium 10 scenes in which the speaker that has been determined to correspond to the user's desired character by the correspondence determination section 40 speaks, and plays back those scenes. In this way, the scenes in which the user's desired character speaks are played back as a digest.

For the digest playback, a maximum amount of time is settable. If the total amount of time of the user's desired scenes exceeds the maximum amount of time, the display control section 50 further narrows downs the scenes to be played back. For example, the display control section 50 preferentially plays back scenes at the end of the story which are considered to be important in the story. Alternatively, for an understanding of the entire video content, scenes at the beginning, in the middle and at the end may be equally played back. Moreover, if the speaker identification section 30 has calculated the ratios of subtitle display times for the speaker corresponding to the user's desired character, scenes in which that ratio is larger may be played back preferentially. This allows playback of scenes in which the user's desired character speaks many lines, enabling an easy understanding of the story of the video content.

A storage section 80 stores the thumbnails of the characters generated by the character identification section 20 and the results of determination made by the correspondence determination section 40, while associating the thumbnails and the determination results with program series of the video content recorded in the recording medium 10. In playing back video content composed of a series of parts, the display control section 50 presents thumbnails of characters in the series, which are stored in the storage section 80, to the user through the output interface 60 to receive character selection made by the user through the input interface 70. And the display control section 50 refers to determination results which have been made for the series by the correspondence determination section 40 and stored in the storage section 80, reads from the recording medium 10 scenes in which the speaker corresponding to the user's desired character speaks, and plays back the read scenes. In this way, in the case of video content, such as a drama, which is composed of a series of episodes, if correspondences between thumbnails of characters and speakers are generated from broadcast data for any one of the episodes, it is not necessary to produce correspondences between the thumbnails of the characters and the speakers again when a digest of broadcast data for another episode is played back. This enables the processing speed to be increased and the power consumption to be reduced.

It should be noted that information to be stored in the storage section 80 may be stored in the recording medium 10. Alternatively, such information does not necessarily have to be stored, and the storage section 80 may thus be omitted.

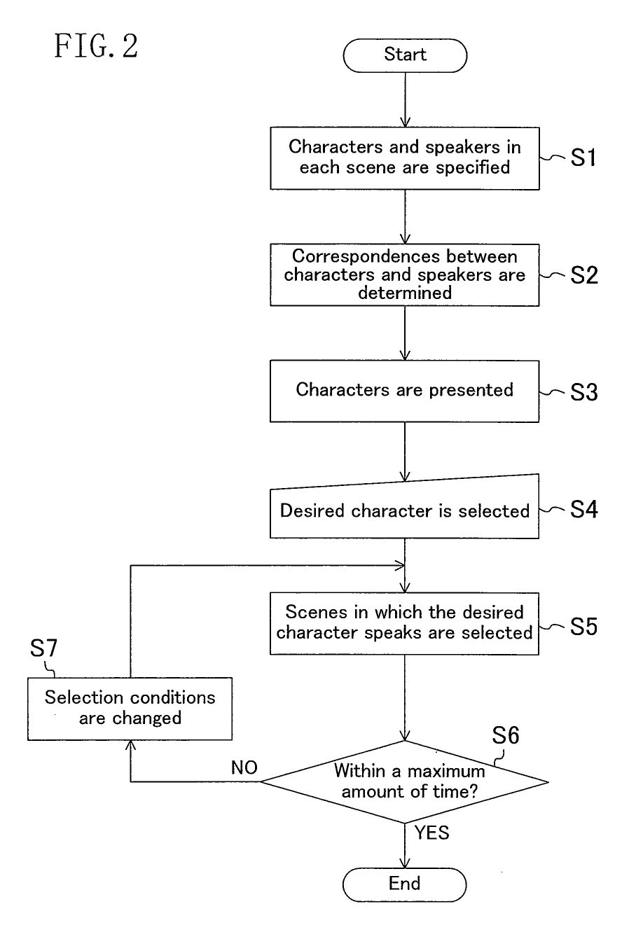

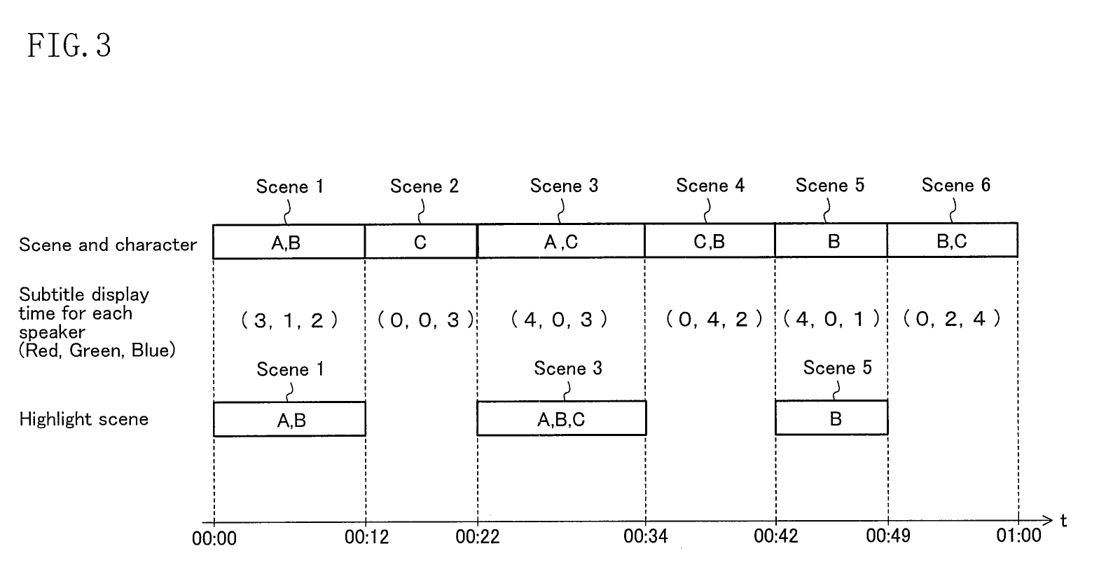

Next, operation of the digest playback apparatus according to this embodiment will be described specifically. FIG. 2 shows the flow of operation performed by the digest playback apparatus according to this embodiment. FIG. 3 schematically shows how highlight scenes are extracted. It is assumed that video content whose digest will be played back is composed of six scenes 1 to 6. The respective lengths of the six scenes 1 to 6 are 12, 10, 12, 8, 7, and 11 minutes.

First, after digest playback processing is started, characters and speakers are identified and specified for each of the scenes 1 to 6, and thumbnails of the characters are generated (S1). As a result, for the scene 1, it is specified that the characters are A and B and that the number of speakers is three (whose letter colors are red, green and blue, respectively). Subtitle display times for the three speakers are 3, 1, and 2 minutes, respectively. Likewise, for the other scenes, characters and speakers are specified, and subtitle display times are calculated.

Next, correspondences between the characters and the speakers are determined (S2). In the scene 2, there are only one character C and the blue speaker. Therefore, the character C and the speaker represented by the blue color match, that is, it is determined that the subtitles displayed in blue are for the character C. Then, in the scenes 4 and 6, the characters are B and C, and the speakers are those represented by the green color and the blue color. Since for the character C, his or her subtitle letter color has already been known, the character B and the speaker represented by the green color match, that is, it is determined that the subtitles displayed in green are for the character B. And it is then found that the remaining character A matches the speaker represented by red. As a result, it is determined that the subtitle letter colors for the characters A, B, and C are red, green, and blue, respectively.

In the case of video content composed of a series of parts, if correspondences between characters and speakers have already been determined and recorded, Step S3 may be omitted by referring to such recorded information.

The thumbnails of the characters generated in Step S1 are presented to the user (S3), and the user selects a desired character (S4). In this embodiment, it is assumed that the character A has been selected. It is also assumed that the digest playback time has been set to 25 to 35 minutes. Step S2 may be performed after Step S4.

After the user's desired character has been selected, scenes in which that character speaks are selected as highlight scenes (S5). In this step, the scenes 1, 3, and 5, in which the subtitles are displayed in the red color, i.e., the subtitle letter color for the character A, are selected as highlight scenes. The total amount of time of these scenes is 31 minutes, which is within the maximum amount of time (YES in S6). Hence these scenes 1, 3 and 5 will be played back as a digest of the video content.

If the total amount of time of the selected highlight scenes exceeds the maximum amount of time (NO in S6), the highlight scene selection conditions are changed as necessary (S7), and the process returns to Step S5. The conditions may be changed as follows. For example, emphasis may be placed on a scene at the end of the content, or high priority may be given to a scene in which the ratio of the subtitle display time for the user's desired character to the duration of the scene is high.

As described above, according to this embodiment, it is possible to play back, as a digest, scenes in which the user's desired character speaks. Thus, scenes in which the user's desired character does not appear on the screen but speaks his or her lines are selectable (for example, the scene 3 in FIG. 3). The digest that is played back in this manner contains a lot of verbal information, thereby facilitating an understanding of the story.

What is claimed is:

1. An apparatus for playing back a digest of recorded video content, comprising:
a character identification section for identifying characters to specify one or more characters in each of scenes in the video content according to video data in the video content, and generating images of the identified characters;
a speaker identification section for identifying speakers to specify one or more speakers in each of the scenes in the video content according to subtitle data in the video content;
a correspondence determination section for determining, based on results of the character identification section's specification of the characters and the speaker identification section's specification of the speakers in the scenes in the video content, a correspondence between each of the characters identified by the character identification section and each of the speakers identified by the speaker identification section; and
a display control section for controlling display of the images of the characters generated by the character identification section to receive selection of a character desired by a user, and playing back one or more of the scenes in the video content in which a speaker speaks, who is determined to correspond to the selected character by the correspondence determination section.

2. The apparatus of claim 1, wherein when switching occurs between speakers identified by the speaker identification section, the character identification section identifies a character by referring to a still image contained in the video data at the time of the occurrence of the switching.

3. The apparatus of claim 1, wherein the character identification section performs a discrete cosine transform on part of a still image contained in the video data which shows a face of a human, and identifies a character by a code obtained by the transform.

4. The apparatus of claim 1, wherein the speaker identification section obtains information on colors of letters of subtitles or textual information added to the subtitles from the subtitle data, and identifies the speakers according to the letter color information or the textual information.

5. The apparatus of claim 1, wherein if there is a scene which has been determined to have one character by the character identification section and determined to have one speaker by the speaker identification section, the correspondence determination section determines that the character and the speaker correspond to each other.

6. The apparatus of claim 5, wherein if there is a scene which has been determined to have n characters by the character identification section and determined to have n speakers by the speaker identification section, and in which correspondences between n−1 characters of the n characters and n−1 speakers of the n speakers have already been determined, the correspondence determination section determines that the remaining one character and the remaining one speaker correspond to each other.

7. The apparatus of claim 5, wherein the speaker identification section calculates, for each of the scenes in the video content, a ratio of a subtitle display time for each speaker in that scene to the duration of that scene; and
when there are a plurality of scenes that satisfy said conditions, the correspondence determination section determines, based on results of the character identification section's specification of the characters and the speaker identification section's specification of the speakers for one of the scenes in which the ratio calculated by the speaker identification section is larger than the ratios in others of the scenes, a correspondence between each of the characters identified by the character identification section and each of the speakers identified by the speaker identification section.

8. The apparatus of claim 1, wherein the speaker identification section calculates, for each of the scenes in the video content, a ratio of a subtitle display time for each speaker in that scene to the duration of that scene; and
the display control section preferentially plays back a scene, in which the ratio calculated by the speaker identification section for the speaker who has been determined to correspond to the selected character by the correspondence determination section is larger than the ratios in others of the scenes.

9. The apparatus of claim 1, wherein the display control section preferentially plays back a scene close to an end of the video content.

10. The apparatus of claim 1, wherein the display control section equally plays back scenes at a beginning, in a middle and at an end of the video content.

11. The apparatus of claim 1, comprising a storage section for storing the images of the characters generated by the character identification section and results of the determination made by the correspondence determination section, while associating the images and the determination results with a series of programs in the video content, wherein when the display control section plays back a video content which is an episode of a series, the display control section controls display of the images of the characters in the series, which are stored in the storage section, to receive selection of a character desired by a user, and plays back one or more of the scenes in the video content, in which a speaker speaks, who is determined to correspond to the selected character according to the results of the determination made for the series by the correspondence determination section and stored in the storage section.

12. A method for playing back a digest of recorded video content, comprising the steps of:
(a) identifying characters to specify one or more characters in each of scenes in the video content according to video data in the video content, and generating images of the identified characters;
(b) identifying speakers to specify one or more speakers in each of the scenes in the video content according to subtitle data in the video content;
(c) determining, based on results of the specification of the characters and the specification of the speakers in the scenes in the video content performed in the steps (a) and (b), a correspondence between each of the characters identified in the step (a) and each of the speakers identified in the step (b); and
(d) displaying the images of the characters generated in the step (a) to receive selection of a character desired by a user, and playing back one or more of the scenes in the video content in which a speaker speaks, who is determined to correspond to the selected character in the step (c).

13. The method of claim 12, wherein in the step (a), when switching occurs between speakers identified in the step (b), a character is identified by referring to a still image contained in the video data at the time of the occurrence of the switching.

14. The method of claim 12, wherein in the step (a), a discrete cosine transform is performed on part of a still image contained in the video data which shows a face of a human, and a character is identified by a code obtained by the transform.

15. The method of claim 12, wherein in the step (b), information on colors of letters of subtitles or textual information added to the subtitles is obtained from the subtitle data, and the speakers are identified according to the letter color information or the textual information.

16. The method of claim 12, wherein in the step (c), if there is a scene which has been determined to have one character in the step (a) and determined to have one speaker in the step (b), the character and the speaker are determined to correspond to each other.

17. The method of claim 16, wherein in the step (c), if there is a scene which has been determined to have n characters in the step (a) and determined to have n speakers in the step (b), and in which correspondences between n−1 characters of the n characters and n−1 speakers of the n speakers have already been determined, the remaining one character and the remaining one speaker are determined to correspond to each other.

18. The method of claim 16, wherein in the step (b), for each of the scenes in the video content, a ratio of a subtitle display time for each speaker in that scene to the duration of that scene is calculated; and
in the step (d), when there are a plurality of scenes that satisfy said conditions, a correspondence between each of the characters identified in the step (a) and each of the speakers identified in the step (b) is determined based on results of the specification of the characters and the specification of the speakers performed in the steps (a) and (b) for one of the scenes in which the ratio calculated in the step (b) is larger than the ratios in others of the scenes.

19. The method of claim 12, wherein in the step (b), for each of the scenes in the video content, a ratio of a subtitle display time for each speaker in that scene to the duration of that scene is calculated; and
in the step (d), a scene, in which the ratio calculated in the step (b) for the speaker who has been determined to correspond to the selected character in the step (c) is larger than the ratios in others of the scenes, is played back preferentially.

20. The method of claim 12, wherein in the step (d), a scene close to an end of the video content is played back preferentially.

21. The method of claim 12, wherein in the step (d), scenes at a beginning, in a middle and at an end of the video content are equally played back.

22. The method of claim 12, comprising the steps of:
(e) storing the images of the characters generated in the step (a) and results of the determination made in the step (c), while associating the images and the determination results with a series of programs in the video content; and
(f) when a video content which is an episode of a series is played back, displaying the images of the characters in the series, which are stored in the step (e) to receive selection of a character desired by a user, and playing back one or more of the scenes in the video content, in which a speaker speaks, who is determined to correspond to the selected character according to the results of the determination made for the series in the step (c) and stored in the step (e).
